(19) United States
(12) Patent Application Publication
(10) Pub. No.: US 2017/0225931 A1
(43) Pub. Date: Aug. 10, 2017

(54) COMBINATION BOTTLE OPENER AND BOTTLE CAP COLLECTOR

(71) Applicant: Dakota Farar, Wheaton, IL (US)

(72) Inventor: Dakota Farar, Wheaton, IL (US)

(21) Appl. No.: 15/017,654

(22) Filed: Feb. 7, 2016

(51) Int. Cl. B67B 7/16

(52) U.S. Cl. CPC B67B 7/16

(57) ABSTRACT

A bottle opener for pry-off bottle caps includes a magnetic bottle cap collector and organizer. A magnet is fled to a location on the opener near where the bottle cap is engaged, in a specific position that enables the magnetic force to attract the removed bottle cap, causing the cap to flip onto the piece of magnetic material, thereby becoming magnetized. A user then positions the subsequently-removed cap onto the previously-removed caps. The magnetic piece provides an attractive force having a magnitude sufficient to retain the bottle caps in a hanging stack extending from the magnetic piece.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to bottle openers, and specifically to a bottle opener combined with a magnet that collects the removed bottle caps.

2. Description of the Related Art

Bottle cap openers have been combined with a multitude of other kitchen and bar tools. There are combination openers and devices that collect the removed bottle cap, such as devices that remove the bottle cap with a built-in receptacle to collect the cap. Additionally, wall-mounted magnets have been positioned underneath a standard wall-mounted bottle top opener to collect the removed caps as they fall. However, a resulting magnetically-clustered accumulation of removed caps inhibits positioning of a subsequent bottle for cap removal. Magnetic hand-held bottle can openers retain the removed cap at the point of contact, and so the removed cap remains as an obstruction, inhibiting engagement of a subsequent bottle top for cap removal. A user must manually remove each cap from the opener and dispose of the cap, which is inefficient in a high volume commercial setting. A bottle cap opener which permits successive removal, collection, and organization of removed bottle caps is needed, so that multiple bottles may be opened without the removed bottle caps becoming an obstruction.

### BRIEF SUMMARY OF THE INVENTION

The invention is a bottle opener for pry-off bottle caps combined with a magnetic bottle cap collector and organizer. A magnetic is fixed to a location on the opener, in a position that enables tile magnetic force to attract the removed bottle cap. The cap flips onto the piece of magnetic material and becomes magnetized. A new bottle can be opened without the previously-removed bottle cap obstructing positioning of the bottle top. Multiple beak caps are retained together on the opener by magnetization.

### BRIEF DESCRIPTION OF THE SEVERAL VIEWS OF THE DRAWINGS

FIG. 1 is a view in perspective of the in showing the planar bottle opener and magnetic piece.

FIG. 2 is a view in perspective underneath the bottle opener showing a bottle cap retained in the magnet, with a solid curved arrow showing a subsequently-removed bottle cap flipping semi-rotational toward the magnetized bottle cap.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

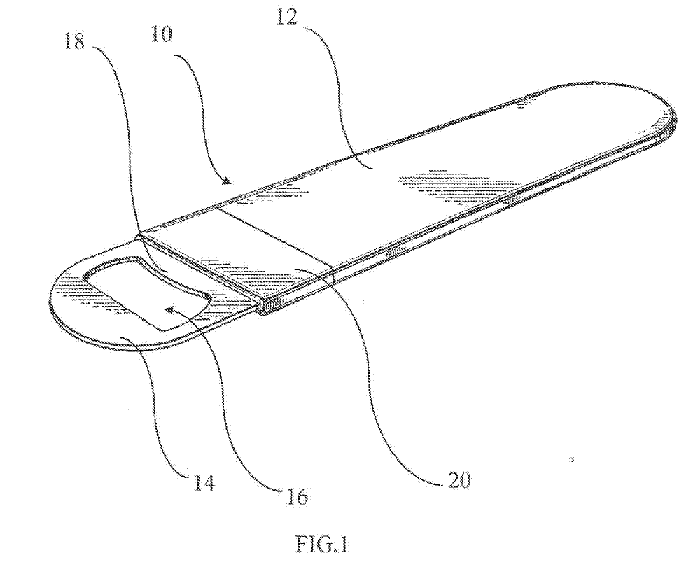

FIG. 1 shows the preferred embodiment for the invention. A bottle opener 10 has a lever 12 formed longitudinal and planar. A housing 14 formed at a first end engages a top portion of a bottle (not shown) that is sealed with a pry-off bottle cap. The housing 14 has portions defining an aperture 16 that receive the bottle top portion and a prying device 18 for positioning between a cap and bottle top and exerting a force to remove the cap and open the bottle. A magnetic material 20 is formed in combination with the bottle opener 10, preferably substantially planar to the lever 12.

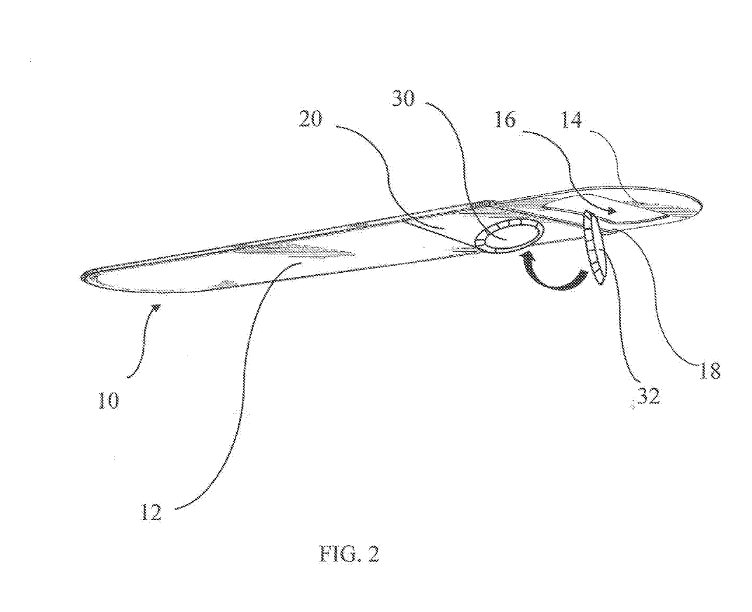

As shown in FIG. 2, a removed bottle cap 30 is retained the magnetic material 20. The magnetic material 20 is positioned adjacent to the housing 14, in proximity to the aperture 16 for exerting a magnetic force on a subsequently-removed bottle cap 32, as shown in FIG. 2. The magnetic material 20 must be strong enough to overcome gravity and retain the removed caps 30 and 32.

The magnetic material 20 must be positioned to orient magnetic field lines that impose an attractive magnetic force on the removed bottle cap 32 rather than repel the cap 32 away from the bottle opener 10. The magnetic material 20 utilized is particularly strong for collecting, retaining and of removed bottle caps 30 and 32, as well as subsequently-removed caps. The removed caps 30 and 32 ultimately held together by magnetic force provided by the magnetic material 20.

The magnetic material 20 causes the removed cap 32 to flip semi-rotational, meaning approximately 180 degrees. In FIG. 2, the flipping action path of the newly-removed cap 32 is represented by the bold arrow. In the FIGS., the magnetic material 20 is positioned about one centimeter from the aperture 16.

The magnetic material 20 must be strong enough to retain the removed cap onto the bottle opener 10. Subsequently removed bottle caps flip in a like manner onto the previously-removed bottle cap in a stacking fashion, until the stack is thicker than the diameter of the bottle cap. Removed bottle caps are magnetically attracted onto the nascent stack, and the user must then begin manually organizing the stack and add removed caps onto the next position at the growing end of the nascent stack.

The magnetic material 20 has sufficient strength to retain approximately 50 bottle caps. The caps are retained away from the aperture 16, on the magnetic material 20, so that further use of the bottle opener 10 is not inhibited by the previously-removed bottle caps obstructing insertion of a bottle top into the housing 14. The removed caps are organized in a stack, which is initiated in form by the magnetic material 20 on the bottle opener 10. The first removed caps 30 and 32 flipped onto one mother in even stacking formation, caused by the specific positioning of the magnetic material 20 that has a sufficient force.

In conclusion, the present invention in using the aforementioned structure has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein.

1. A bottle opener comprising:
(a) a longitudinal planar lever with at least one end of the lever having a housing formed to engage a bottle top sealed with a pry-off bottle cap; the housing having portions defining an aperture for receiving the bottle top; a prying device disposed on the housing for positioning between the sealed bottle top and the cap and for exerting an opening force to remove the cap from the bottle top;
(b) a magnetic material fixed to the lever adjacent to the housing,
wherein the magnetic material is positioned to produce magnetic field lines acting against the bottle cap to cause a flipping action as the cap is removed, and the magnetic material having a magnetic strength sufficient to retain the removed bottle cap and subsequently-removed bottle caps in a stacked formation.

2. The bottle opener of claim 1, wherein the magnetic material is a planar piece of magnetized metal.

3. The bottle opener of claim 1, wherein the magnetic material is a magnet substantially permanently fixed to the lever.

4. A bottle opener comprising:
(c) a planar lever with a first end of the lever having first and second ends, and a middle portion extending between the ends, the first end formed to receive a bottle top sealed with a pry-off bottle cap; a prying device disposed on the first end for positioning between the sealed bottle top and the cap and for exerting an opening force to remove the cap from the bottle top;
(d) a magnet fixed to the lever;
wherein the magnet is fixed to the middle portion of the lever and causes flipping action as the bottle cap is removed, and the magnet having a force strength sufficient to retain the bottle cap on the magnet.
